(19) United States
(12) Patent Application Publication
(10) Pub. No.: US 2020/0030919 A1
(43) Pub. Date: Jan. 30, 2020

(54) AUTOMATED WELDING SYSTEM FOR INTERCHANGEABLE WELDING HEADS

(71) Applicant: ESAB AB, Gothenburg (SE)

(72) Inventor: Magnus Svedlund, Kumla (SE)

(21) Appl. No.: 16/044,951

(22) Filed: Jul. 25, 2018

(51) Int. Cl. B23K 28/02; B23K 9/095; B23K 9/28; B23K 11/31; B23K 37/02

(52) U.S. Cl. CPC B23K 28/02; B23K 9/095; B23K 37/0294; B23K 11/318; B23K 9/282

(57) ABSTRACT

An automated welding system includes a support structure, a plurality of welding heads, and a controller. The plurality of welding heads are each removably, mechanically coupleable to the support structure. The controller is configured to control welding operations of the automated welding system based on an identity of a particular welding head of the plurality of welding heads that is mechanically coupled to the support structure and operably coupled to the controller.

### TECHNICAL FIELD

The present disclosure is directed toward a welding system and, in particular, an automated welding system that is configured to support a variety of interchangeable welding heads that are installable on the system.

### BACKGROUND

Due, at least in part, to increasing labor costs associated with achieving a high-quality manual weld, automated welding is becoming more and more prevalent. Automated welding typically requires a large initial investment, but if the automated equipment is used frequently, the lower operational costs of automated welding typically offset the higher costs of paying a skilled welder over time. Automated systems come in a variety of form factors. One of the more basic form factors is a welding tractor. At a high-level, a welding tractor supports a welding head on a movable support structure. That is, in at least some forms, a welding tractor simply functions as the extended arm of the operator, holding a welding head or torch at a specific height to provide consistent welding speed and tracking. More advanced tractors may also include additional features to control stop and/or start sequences. Alternatively, automated welding may be effectuated with a welding head installed on a robot, gantry, automated column and boom, etc.

Regardless of how welding operations are automated, automated welding can vastly increase productivity. For example, switching from manual welding (e.g., manual metal inert gas (MIG) or metal active gas (MAG) manual welding) to an automated tractor-based solution generates a vast increase in productivity (e.g., up to 25 times more productivity). Unfortunately, most automated systems automate welding operations only for a single type of welding. For example, many existing welding tractors support only submerged arc welding (SAW) welding. Alternatively, some newer tractors may be slightly reconfigurable, for example, so that the tractor can support a SAW welding head or a gas metal arc welding (GMAW) welding head. However, the reconfiguration is typically difficult, time consuming, and, requires a user to manually reconfigure welding parameters (e.g., via a controller included on the tractor) when switching from SAW to GMAW. Many reconfigurations also require a variety of tools and/or a certified electrician. Additionally, in at least some cases, traditional SAW power sources (e.g., non-inverted based power sources) included on/in an automated system may be unsuitable for GMAW (e.g., a SAW power source may reduce the weld quality of GMAW).

Thus, if an end user needs to utilize different welding operations, the end user may need to complete a difficult reconfiguration or purchase multiple automated systems. Due to the difficulties associated with reconfiguration, end users often purchase two (or more) automated welding systems and dedicate the systems to specific types of welding. For example, an end user may dedicate at least one tractor to SAW and dedicate at least one other tractor to GMAW. Still further, in some instances, an end-user may need to utilize welding techniques other than SAW and GMAW and, thus, even a collection of automated systems may not be suitable for all of the end-user's welding jobs. In this scenario, the end user will be required to pay for manual welding or purchase yet another automated system. Then, in addition to the cost of purchasing a fleet of automated systems, the end user must also store and maintain all of this equipment.

### SUMMARY

The present disclosure is directed toward an automated welding system for interchangeable welding heads that can identify welding heads and automatically configure itself for an identified welding head. The invention can be embodied as method, a system, an apparatus, and executable instructions in a computer-readable storage media to perform the method.

According to at least one example embodiment, a method for configuring an automatic welding system includes identifying a welding head that is mechanically and electrically coupled to the automatic welding system. Then, one or more welding components and one or more parameters are determined to be associated with the welding head and welding is initiated with the welding head using the one or more welding components and the one or more parameters determined to be associated with the welding head. Advantageously, this method allows an automated welding system to be quickly and easily repurposed for different welding operations, such as SAW, GMAW, and gouging.

In at least some of these embodiments, the welding head is an interchangeable welding head that is coupled to a support structure of the automatic welding system via a releasable mechanical coupling. In some instances, the releasable mechanical coupling is a tool-less coupling. This allows a wide variety of end users, with varying skill levels, to easily change attach or detach a welding head from the automated welding system (e.g., to transition to a different welding process) and, in some cases, regardless of the tools that are available. Additionally or alternatively, the welding head may be an interchangeable welding head that is coupled to a controller of the automatic welding system and a power source of the automatic welding system via releasable electrical couplings. In these instances, the welding head can be attached or detached without a certified electrician, thereby increasing the ease of transitioning between welding processes and decreasing the labor costs associated with operating the automated welding system.

In other embodiments, the one or more parameters are selected from a group including: wire feeder gear ratios, wire feed speed, encoder pulse setting, gas flow rates, welding voltage, welding current, flux flow, and travel speed. Additionally or alternatively, the one or more welding components may include a flux subsystem and/or a gas subsystem. Consequently, the automated welding system may be suitable for a wide variety of welding operations.

According to another embodiment, an automated welding system includes a support structure, a plurality of welding heads that are each removably, mechanically coupleable to the support structure, and a controller. The controller is configured to control welding operations of the automated welding system based on an identity of a particular welding head of the plurality of welding heads that is mechanically coupled to the support structure and operably coupled to the controller. Thus, like the method discussed above, this system allows an end-user to quickly and easily repurpose their system for different welding operations, such as SAW, GMAW, and gouging. This may dramatically reduce the size and cost of an end user's automated equipment (e.g., an end user can reduce or eliminate a “tractor park”).

In some of these embodiments, the support structure comprises a base and a column of a welding tractor. In other embodiments, the support structure comprises a column and boom. Moreover, in some embodiments, the automated welding system includes a flux subsystem that can be selectively activated to provide flux for the welding operations of specific welding heads of the welding heads. Additionally or alternatively, the automated welding system may include a gas subsystem that can be selectively activated to provide shield gas for the welding operations of specific welding heads of the welding heads and/or to provide compressed air for carbon arc gouging. Advantageously, additional features or components may render the automated welding system suitable for additional types of welding. Meanwhile, different support structures may allow the automated system to handle different welding jobs.

Regardless of the type of support structure or types of features included in the automated welding system, each of the plurality of welding heads may be removably, mechanically coupleable to the support structure via a tool-less coupling so that the welding heads can be quickly and easily removed from or attached to the support structure. Moreover, in some embodiments, the support structure is configured to support two or more welding heads of the plurality of welding heads at once and the controller controls the welding operations based on identities of each of the two or more welding heads. This may allow the welding system to perform more nuanced or complicated welding techniques, such as tandem SAW techniques.

In some embodiments, the controller of the automated welding system controls the welding operations by limiting a range of one or more parameters, including voltage, travel speed, current, and wire feed speed. This may ensure that an end user does not select dangerous or suboptimal settings for a particular welding head.

According to yet another embodiment, one or more non-transitory computer readable storage media are presented herein. The computer readable storage media are encoded with software comprising computer executable instructions and, when the software is executed, operable to identify a welding head that is mechanically and electrically coupled to an automatic welding system. One or more welding components and one or more parameters are then determined to be associated with the welding head, and welding is initiated with the welding head with the one or more welding components and the one or more parameters determined to be associated with the welding head.

In at least some of these embodiments, the software is also operable to determine one or more ranges of allowable values for each of the one or more parameters, display menu options that are within the one or more ranges, and receive user selections of the menu options and set the parameters in accordance with the user selections. This ensures that end users are presented with only relevant options, which simplifies the configuration process for the end user. This may also ensure that unsafe or suboptimal settings are not selected for a welding operation.

### BRIEF DESCRIPTION OF THE SEVERAL VIEWS OF THE DRAWINGS

FIG. 1 is a perspective view of an example embodiment of an automated welding system, in the form of a welding tractor, on which the techniques presented herein may be employed.

FIGS. 2A and 2B illustrate additional examples of welding tractors on which the techniques presented herein may be employed.

FIG. 2C illustrates an example column and boom system on which the techniques presented herein may be employed.

FIG. 3 is a side view of an interchangeable welding head that may installed on the welding tractor of FIG. 1.

FIG. 4 is a close-up, side perspective view of a connector included on the interchangeable welding head of FIG. 3 while engaged with an attachment point included on a support structure of a welding tractor.

FIG. 5 is a close-up, top perspective view of the attachment point included on the support structure shown in FIG. 4.

FIGS. 6A and 6B are circuitry diagrams that each illustrate electrical connections formed between an interchangeable welding head and a controller included in the automated welding system, according to an example embodiment.

FIG. 7 is a high-level flowchart illustrating a method for automatically reconfiguring an automated welding system for an interchangeable welding head, according to an example embodiment.

FIG. 8 is a chart illustrating resistance signatures associated with interchangeable welding heads, according to an example embodiment.

FIG. 9 is a block diagram depicting a computer system upon which the techniques presented herein may be implemented, according to an example embodiment.

Like numerals identify like components throughout the figures.

### DETAILED DESCRIPTION

Generally, a welding system that can receive and identify interchangeable welding heads is presented herein. Upon identifying an interchangeable welding head, the system automatically configures itself to support welding operations performed with the identified head. That is, once one of the welding heads is electrically connected to a controller included on a welding apparatus (e.g., a tractor or column and boom), the controller can identify the welding head based on electrical properties of the welding head (e.g., each welding head or cabling associated with the welding head may have an identifying resistor with a unique resistive value) and configure features (e.g., activate or de-activate components, such as a flux subsystem) and/or welding parameters (e.g., limit the range of wire feed speeds) accordingly. Consequently, an end user can use a single automation system for multiple types of welding operations and the end user can quickly and easily switch between these welding operations. For example, an end user (i.e., an operator) can easily switch between submerged arc welding (SAW), gas metal arc welding (GMAW), gouging, twin wire SAW, etc., simply by installing different interchangeable and operation-specific welding heads onto a welding tractor.

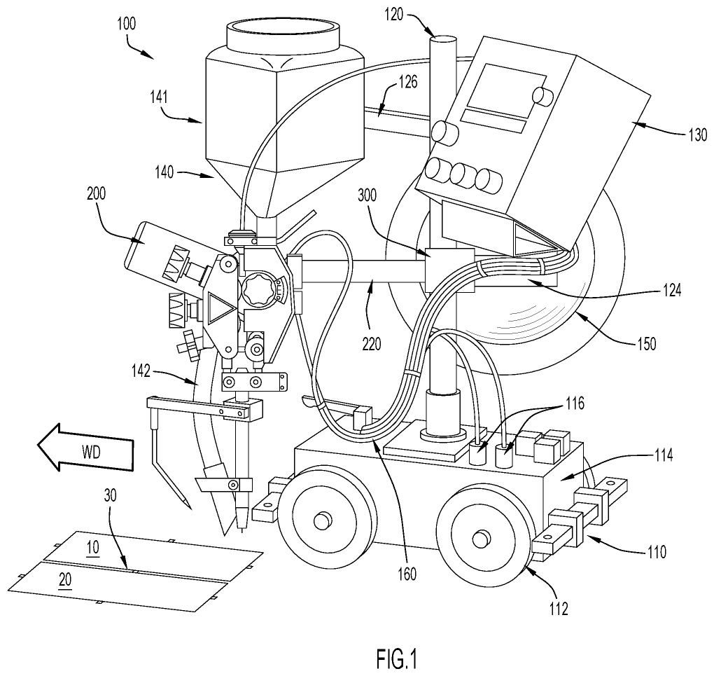

Now turning to FIG. 1, generally, the welding system presented herein may be embodied as a welding tractor, a column and boom system, or any other automatic welding arrangement; however, for simplicity, the welding system is largely illustrated and described herein in connection with welding tractors with the understanding that welding tractors are merely an example of an automated welding system. FIG. 1 illustrates an example tractor 100. The tractor 100 includes a base 110 with wheels 112 that allow the tractor 100 to move relative to one or more workpieces. As an example, in FIG. 1, the tractor 100 is shown moving in a weld direction “WD” alongside workpieces 10 and 20 so as to form a weld joint 30 therebetween.

In the embodiment depicted in FIG. 1, the base 110 includes a column 120 that extends upwards from a top surface of the base 110. In some embodiments, the base 110 may be motorized or free-wheeling (e.g., non-motorized). As an example, the base 110 may house a battery and a motor that is operable to drive wheels 112 in response to instructions from the controller 130. Additionally, the base 110 may, in some embodiments, include and/or support a welding power source 114. As an example, the tractor 100 depicted in FIG. 1 depicts the welding power source 114 within the base 110 and the welding power source 114 is connected to a welding head 200 via connectors 116. Preferably, the welding power source 114 is an inverter-based power source that can provide power that is suitable for GMAW, SAW, Carbon arc Gouging, shielded metal arc welding (SMAW), electroslag strip welding (ES SW) and other welding operations, but could also be any power source (e.g., a welding converter, a welding transformer, a rectifier, and/or a thyristor controlled rectifier) that supports any combination of these welding operations. For example, in some embodiments, the welding power source 114 might include two parallel direct current (DC) power sources and/or two parallel alternating current (AC) power sources capable of supporting SAW with a single wire, twin wires, and/or tandem SAW operations. Regardless of the particular implementation of the welding power source 114, the welding power source 114 can provide current to any consumable(s) 150 fed through the welding head (a contact tube 250 included in the welding head transfers the current to the consumable 150).

The column 120 provides a mounting point for welding components and/or support arms that extend away from the column 120 to support various welding components. More specifically, in the embodiment depicted in FIG. 1, the column 120 includes a first support arm 124 and a second support arm 126. The first support arm 124 extends perpendicularly from the column 120 and supports a controller 130 a distance away from the column 120. The second support arm 126 extends perpendicularly from the column 120 and supports a flux subsystem 140 a distance away from the column 120. The column 120 also supports an attachment point 300 onto which a plurality of interchangeable welding heads may be attached. In FIG. 1, an example SAW head 200 is shown attached to the attachment point 300; however, the attachment point 300 is configured to support any type of welding head, such as a GMAW head of a gouging head, as is described in further detail below. Although not shown, a third arm may also extend from the Colum 120 to support a welding consumable 150 (e.g., welding wire), or more specifically, to support a spool on which a welding consumable 150 is coiled (or otherwise stored).

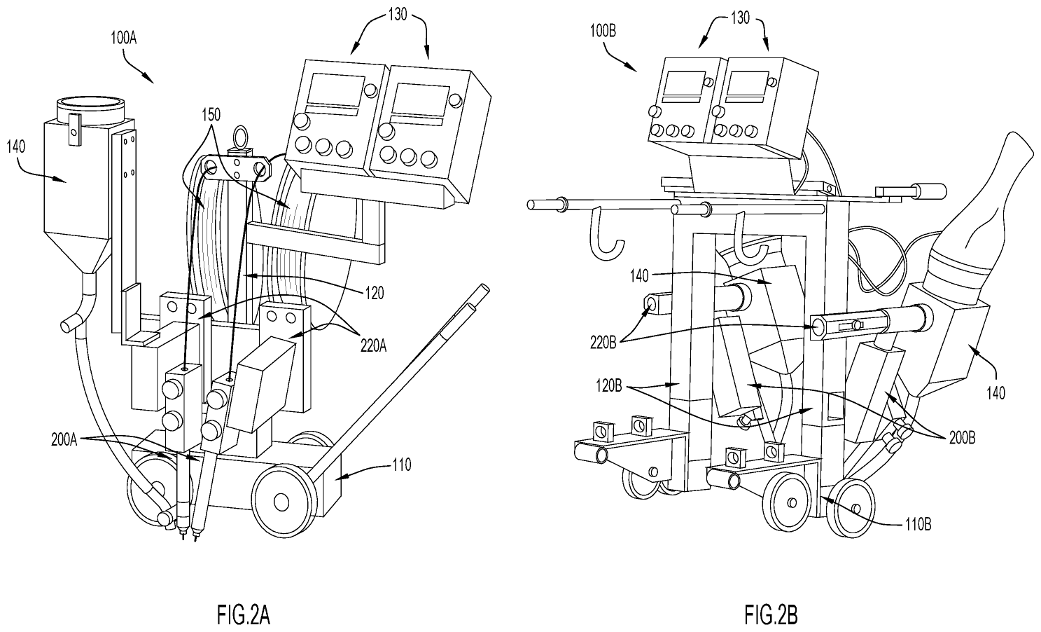

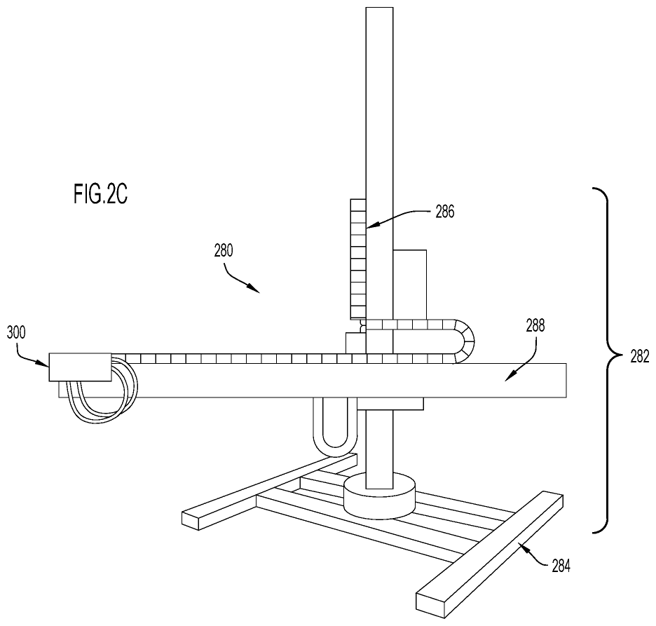

Collectively, the base 110, column 120, and any arms or attachment points included thereon or extending therefrom (e.g., arms 124 and 126, as well as attachment point 300) may be referred to as the automated welding system's support structure. The support structure supports (e.g., houses or holds), each of the welding power source 114, the controller 130, the flux subsystem 140, the consumable 150, and the welding head 200 in fixed or adjustable positions and, to achieve this, any or all parts of the support structure may be adjustable, movable, and/or extendable. Moreover, in different embodiments, the support structure may include fewer or more parts so that, overall, the support structure has any shape or size (two additional examples of different support structures are shown in FIGS. 2A and 2B). That being said, in the particular embodiment depicted in FIG. 1, arms 124 and 126 and attachment point 300 may each be movably coupled to the column 120 so that the arms 124 and 126 and attachment point 300 are each vertically movable on the column 120. Additionally or alternatively, arms, 124 and 126 and attachment point 300 may be rotatable around the column 120 so that the welding head 200, controller 130, and flux subsystem can be angularly repositioned with respect to base 110 (e.g., to align the welding head 200 with a joint 30 and/or move the controller 130 to an accessible position). For example, arms 124 and 126 may each have two degrees of freedom with respect to column 120 (vertical translation and rotation about a vertical axis) while the attachment point has one degree of freedom with respect to column 120 in (vertical translation).

Still referring to FIG. 1, in order to provide automated welding operations on the tractor 100, the welding power source 114 is operably coupled to at least the welding head 200 and/or the controller 130 via leads 160. Additionally, the controller 130 is operably coupled to the welding head 200 via leads 160 so that the controller 130 can send signals to the welding head 200 to control various aspects of the welding head 200, such as a feed speed of the consumable 150. As is explained in further detail below, each interchangeable welding head 200 may include connection points that enable the welding head 200 to be electrically connected or disconnected to the controller 130 without adjusting any wiring. Consequently, a welding head 200 can be electrically connected or disconnected to the controller 130 (via leads 160) without a certified electrician supervising/performing the connection operations. In some embodiments, the tractor 100 may also include leads 160 to operably connect the welding power source 114 to motors configured to drive wheels 112 and control a travel speed of the tractor 100 in the welding direction WD. Additionally or alternatively, the welding power source 114 may also supply power to the welding head to operate gas flow (e.g., shield gas or compressed air) from a gas container connected to the welding head 200.

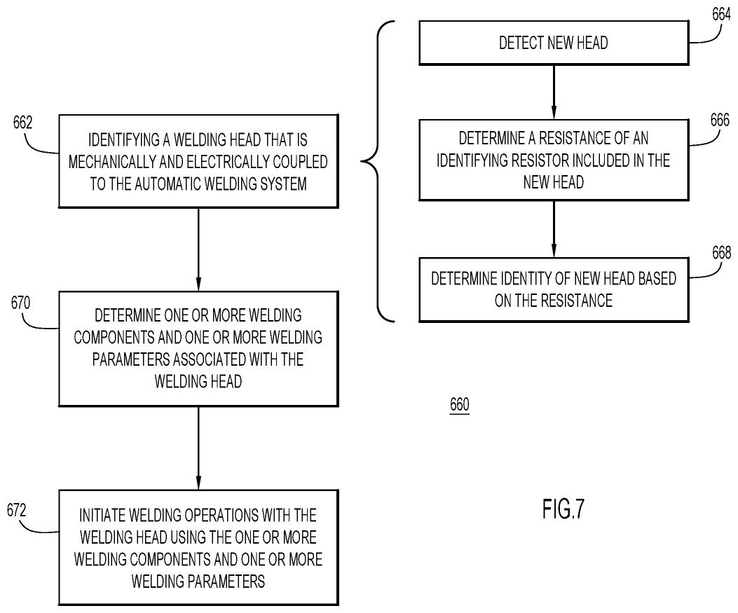

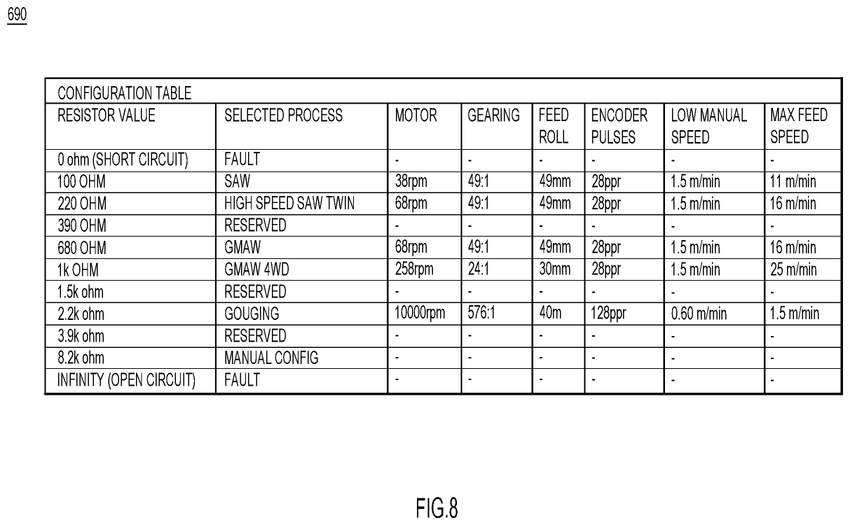

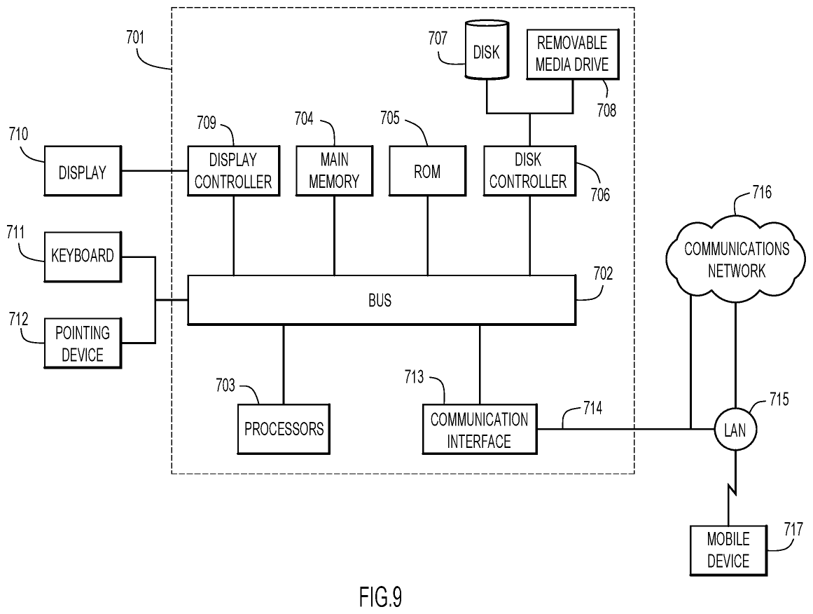

Due to these connections, the controller 130 can configure, operate, and/or activate various welding components included on the automated welding system, such as the flux subsystem 140 and the welding head 200. More specifically, and as is described below in connection with FIGS. 7 and 8, in some embodiments, the controller 130 may include a memory with logic suitable to identify a welding head 200 connected to controller 130 and adjust various welding parameters accordingly. Alternatively, these operations (e.g., identifying and configuring) may be executed by components included in the welding power source 114 (i.e., the controller 130 may be a user interface and the welding power source 114 may identify welding heads 200 and configure the system accordingly). In still further embodiments, these operations may be executed by computing devices that are remote from the tractor 100 and connected thereto via a network connection (i.e., a network connection formed by a communication interface included in the controller 130). An example computing device that is representative of controller 130 is described below in connection with FIG. 9.

FIGS. 2A and 2B illustrate two other example embodiments of welding tractors. FIG. 2A illustrates a welding tractor 100A that includes two controllers 130, two spools of consumables 150, and two welding heads 200A mounted on a base 110 that is substantially similar to the base 100 shown in FIG. 1. However, now, the welding heads 200A are mounted to the column 120 via couplings 220A. Couplings 220A may differ in appearance from the coupling arm 220 of FIG. 1; however, it is to be understood that couplings 220A may also allow welding heads 200A to be releasably, mechanically coupled to the support structure (e.g., column 120) of tractor 100A. Moreover, the couplings 220A allow two welding heads 200A to be installed in tandem (i.e., one in front of the other); thus, tractor 100A may be suitable for tandem welding, be it with two hot wires or one hot wire and one cold wire.

The tractor 100B shown in FIG. 2B also includes two welding heads 200 and two controller 130; however, now these components are included on a split base 110B with a U-shaped column 120B so that the tractor can weld materials disposed between the two segments of the base 110B. Due to the shape of the support structure, the welding heads are again mounted to the support structure of tractor 100B via different mountings 220B. Like couplings 220A, although couplings 220B may differ in appearance from the coupling arm 220 of FIG. 1, it is to be understood that couplings 220B may also allow welding heads 200B to be releasably, mechanically coupled to the support structure (e.g., U-shaped column 120B) of tractor 100B.

Notably, in FIG. 2B, each welding head 200B has its own flux subsystem 140, while in FIG. 2A, the two welding heads 200 share one flux subsystem 140. This is because the welding heads 200 included on tractor 100A operate in the same weld puddle while the welding heads 200 included on tractor 100B operate in separate weld puddles (creating separate weld beads). For example, tractor 100B may, in at least some instances, straddle a stiffener (i.e., a standing plate) that is being welded to a sheet plate so that the two welding heads 200 are welding on both sides of the plate used as stiffener (as is common on ship panels). However, that all being said, the example tractors depicted in FIGS. 1, 2A, and 2B are not intended to be limiting, and it is envisioned that welding heads 200 and flux subsystems 140 might be included on the same support arm of any type of welding tractor, column, and boom, or other such support system. In fact, it may be advantageous to include a welding head and a flux system on the same support arm to make it easier to install or removal a welding head and a flux subsystem at once (since both the welding head and a flux subsystem could be installed or removed in one operation). As a specific example, in the embodiment depicted in FIG. 1, the welding head 200 and flux subsystem 140 may each be mounted on arm 220.

To reiterate, the tractors 100A and 100B shown in FIGS. 2A and 2B, as well as the tractor 100 shown in FIG. 1, are simply examples of automated welding systems and in other embodiments, the automated welding system presented herein may be embodied in any form. For example, an automated column and boom, such as the column and boom 280 shown in FIG. 2C, can also include the welding components (e.g., controller 130, flux subsystem 140, leads 160, consumable 150, and welding head 200) illustrated on tractors 100, 100A, and 100B, with the column and boom essentially replacing the support structure of the tractors 100, 100A, and 100B. In fact, in at least some embodiments, a column and boom support structure (or any other automated welding system support structure) might include the attachment point 300 so that a single set of interchangeable welding heads 200 can be transferred between different support structures (and so that a variety of welding heads intended for a variety of welding operations can be installed on the column and boom). For example, in the embodiment depicted in FIG. 2C, a column and boom 280 includes a support structure 282 with a base 284, a column 286, and a boom 288. The boom 288 can move vertically on the column 286 and the boom 288 supports an attachment point 300 that the boom 288 can move horizontally with respect to the column 286. Thus, for example, an end user might be able to execute a wide variety of welding jobs with only one SAW head, one GMAW head, one gouging head, and one column and boom assembly or one tractor.

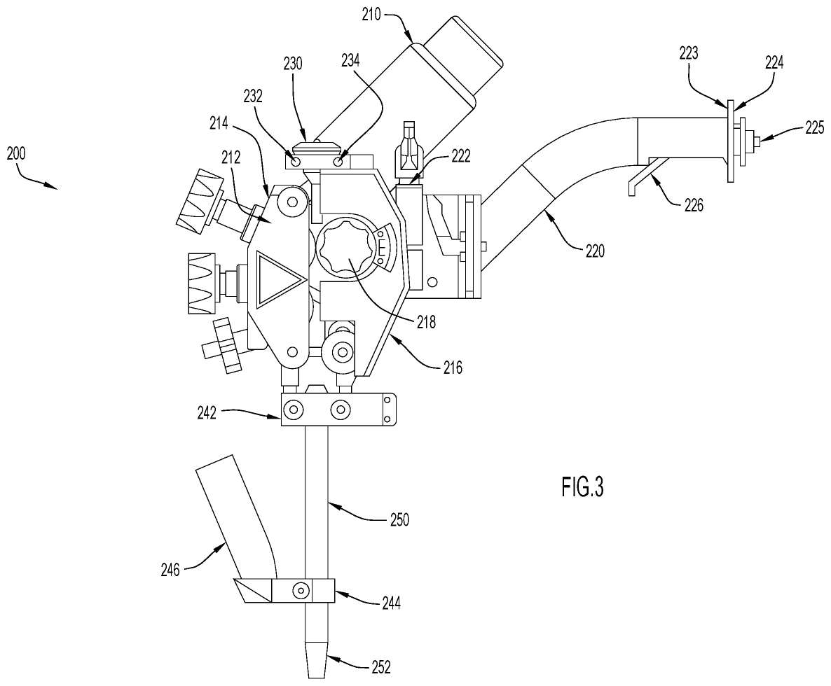

Now turning to FIG. 3, this Figure illustrates an example embodiment of an interchangeable welding head 200 for an automated welding system. At a high-level, the welding head 200 includes a motor 210, a wire management component 212, a connector arm 220 (also referred to herein simply as arm 220), and a contact tube 250. The wire management component 212 may be a wire feeder and/or a wire straightener and the motor 210 is operably coupled to the wire management component 212 so that the motor can drive any components included in the wire management component 212 (e.g., a feed roller). That said, in the depicted embodiment, the wire management component 212 is a wire feeder that is disposed between a top 230 of the welding head 200 and the contact tube 250 ad includes a pressure mechanism 214, a safety guard 216, and a roller 218. The pressure mechanism 214 may compress a consumable, such as consumable 150, against the roller 218 and the motor 210 may drive rotation of the roller 218 (e.g., counter-clockwise rotation in the depicted view) to feed the consumable to the contact tube 250 of the welding head 200. The contact tube 250 may transfer electricity to the consumable 150 in accordance with any techniques now known or developed hereafter. The contact tube 250 is disposed at a bottom of the welding head 200 so that a distal end 252 of the contact tube 250 defines the bottom of the welding head 200 and is disposed closest to a join 30 during welding.

However, the depicted wire management component 212, motor 210, and contact tube 250 are merely examples and in other embodiments a welding head 200 may include any combination of these components. For example, a welding head 200 for tandem SAW welding may include two wire feeders, two motors, and two contact tubes (or three of each) and, in some of these embodiments, at least some of the contact tubes may be insulated (e.g., to insulate a cold wire). Alternatively, a welding head may include similar components as compared to the welding head 200 depicted in FIG. 2, but the wire management component 212 may include two grooved wheels that engage either side of a consumable and rotate in opposite directions to move the consumable towards a workpiece. The roller 218, as well as any other grooved wheels or other such feeding components may be coupled to driving motors via any desirable drive shaft, power train, gearing arrangement, or other such mechanical coupling that allows rotational energy to be imparted to the feeders. Moreover, although not shown, in some embodiments an interchangeable welding head 200 may include or be coupled to a straightener or straightening unit configured to straighten and/or align a consumable as it is drawn from its coil/spool (i.e., as consumable 150 approaches wire management component 212). For example, top 230 may be coupled to a wire straightening unit.

Regardless of how the wire management component 212 feeds a consumable 150 to the contact tube, once a consumable 150 to the contact tube 250, the contact tube 150 aligns the consumable with the joint 30 to effectuate welding operations. In embodiments including more than one consumable 150, the contact tubes may align the consumables in the welding direction WD (e.g., see FIG. 1) so that the welding system guides the consumables to the same portion of a work piece as the welding operations move in the welding direction WD. That is, the consumables may be spaced a distance from each other in the welding direction WD, insofar as “welding direction” is the direction in which a weld is intended to run (i.e., the welding direction is the direction of movement of a welding head 200. However, in other embodiments, two or more consumables can be arranged in various settings or formations. For instance, consumables can be disposed along an axis that is perpendicular to the welding direction WD, spaced different distances from each other in the welding direction, or a combination thereof. If two or more consumables are spaced along an axis that is perpendicular to the welding direction WD (i.e., spaced along a “transverse axis”), the consumables may be positioned side by side, for example, to weld a wide span at once. By comparison, when the consumables are aligned in the welding direction, the consumables may perform different roles in a single welding pass.

Still referring to FIG. 3, the welding head 200 also includes various connection points, such as connectors 232, 234, and 242 to provide electrical and/or signal connections to the welding head 200. These connectors 232, 234, 242 may be or include male or female portions of any other type of connector that allows the welding head 200 to be simply and quickly connected to leads 160 without a certified electrician. For example, connectors 232 and/or 234 may include male portions of a power coupling (e.g., a bayonet coupling) with an insulated exterior and the leads 160 may include corresponding female portions so that leads 160 can be quickly and easily electrically connected (or disconnected) to a welding head 200. In some embodiments, connectors 232, 234, 242 may also provide gas connections (e.g., the leads 160 may be cable hoses).

Now referring to FIG. 3 in combination with FIG. 1, in the depicted embodiment, the welding head 200 is a SAW welding head and, thus, a weld created by welding head 200 is formed beneath a flux covering. Fluxes are generally granular fusible minerals typically containing oxides of manganese, silicon, titanium, aluminum, calcium, zirconium, magnesium and other compounds such as calcium fluoride. Generally, the flux helps to produce a metal weld with a specific chemical composition and specific mechanical properties under a layer of slag. That is, the flux is specially formulated to be compatible with a given consumable(s) so that the combination of flux and the consumable(s) produces desired mechanical properties. In the depicted embodiment, the tractor 100 includes a flux subsystem 140 and the welding head 200 is configured to interface with the flux subsystem 140; however, in other embodiments, an interchangeable welding head might include its own flux subsystem 140 (like welding heads 200B in FIG. 2B) or any other such welding component (e.g., a gas subsystem).

More specifically, as can be seen in FIG. 1, in the depicted embodiment, the tractor 100 includes a flux subsystem 140 with a flux hopper 141 that is configured to deliver flux to a flux drop 142. Meanwhile, the welding head 200 includes a flux nozzle 246 that is secured to the contact tube 250 via a clamp 244 so that the flux nozzle can secure the flux drop 142 adjacent, but in front of (in the welding direction WD) the contact tube 150. Thus, in the depicted embodiment, flux is delivered (i.e., by nozzle 246 and flux drop 142) on the leading edge of the contact tube 150 to produce a protective layer of flux over a weld.

Additionally or alternatively, flux may be delivered around the wire (i.e., on all sides of the wire) with a different type of flux nozzle or to the trailing edge of the contact tube 150 to provide a layer of flux over any molten slag included above the metal weld 52 (i.e., the assembly 110 may include a second or repositioned hopper 160 and drop 162). These additional or alternative flux subsystems may be included on the support structure of an automated welding system (like flux subsystem 140) or may be included entirely on the welding head 200 (although flux is typically only delivered on the trailing edge of a welding head when a second welding head is positioned behind the welding head). Similarly, any welding other welding components (e.g., gas subsystems) may also be included on the support structure of an automated welding system (like flux subsystem 140) or may be included entirely on their welding head 200. As two examples, a GMAW head may include its own gas shielding subsystem and an arc air gouging head may provide its own compressed air nozzle. That is, other welding heads that may be installed onto a support structure (e.g., welding heads other than the SAW head depicted in FIG. 3) may be suitable for any type of welding and may include any features or components necessary to support that type of welding. For example, an interchangeable welding head for GMAW may include a gas nozzle instead of a flux nozzle 246. As was mentioned above, connectors 232, 234, and 242, or variants thereof, may provide any necessary gas, signal, or electrical connections (e.g., via leads 160).

Still referring to FIGS. 1 and 3, regardless of the operational-specific features included on a welding head (e.g., a flux nozzle 246), the welding head 200 includes an arm 220 that allows the welding head 200 to be quickly installed onto (or uninstalled from) the support structure of an automated welding system, such as the column 120 of the tractor 100 shown in FIG. 1. The arm 220 extends from a first or proximate end 222 (the first end 222 is secured to the wire management component 212 in the depicted embodiment) to a distal or second end 223 that includes a connector 224. The connector 224 includes mechanical components that can move (e.g., snap) into engagement with the attachment point 300 (which is shown in FIGS. 1, 4 and 5) included on the support structure of the welding system (e.g., included on the column 120). More specifically, in the depicted embodiment, the connector 224 includes an actuatable engagement member 225 that extends from a flange 227 and that is actuatable by actuator 226. In at least some embodiments, the engagement member 225 may be biased to move towards the flange 227 and may move away from the flange 227 when the actuator 226 is actuated. Due to this biasing, upon release of the actuator 226, the engagement member 225 may move towards the flange 227 so that the flange 227 and engagement member 225 form a clamp or clamp-like device.

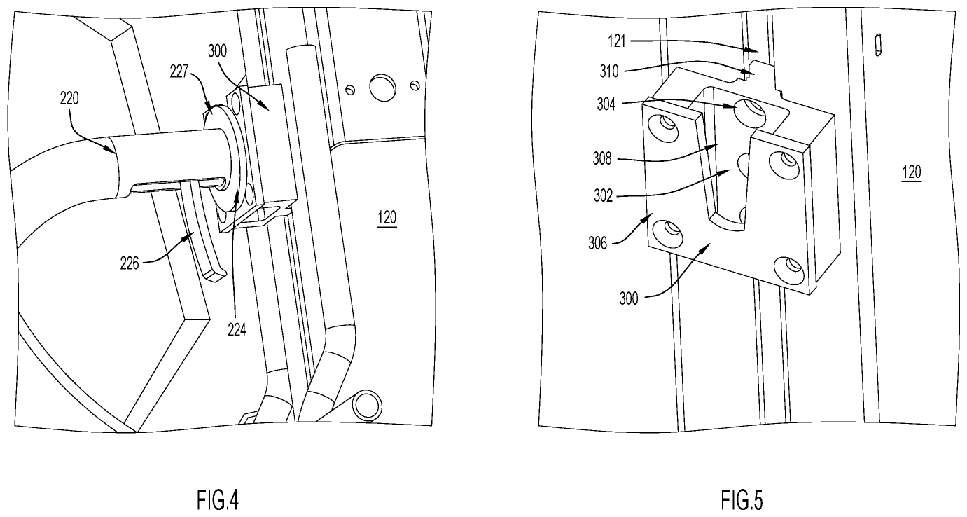

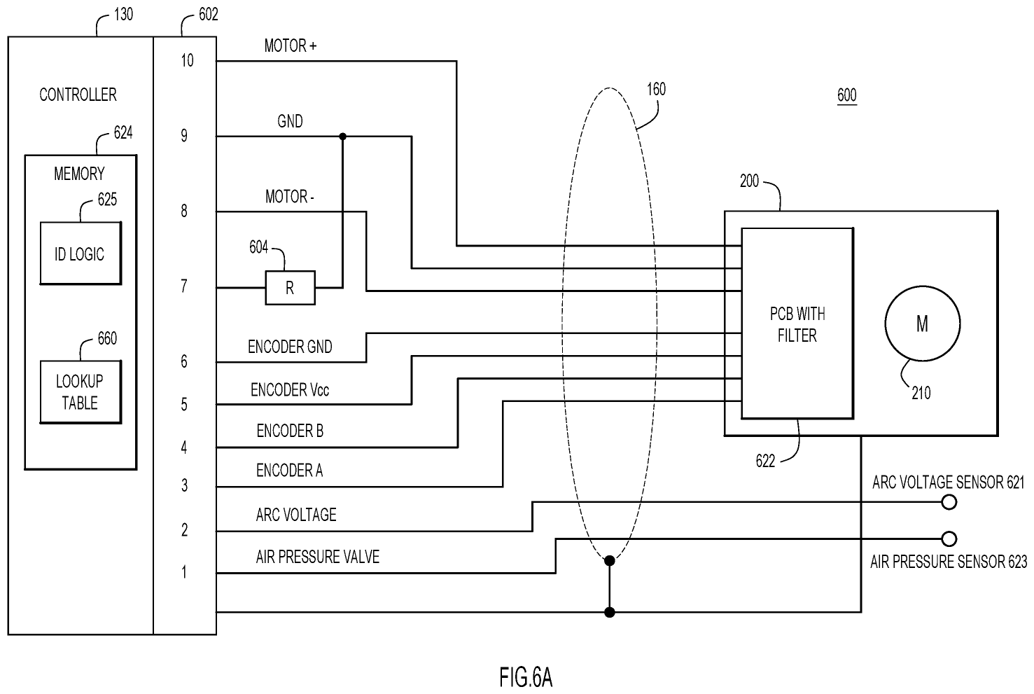

In FIG. 4, the connector 224 is shown in more detail, but while connected to an example embodiment of an attachment point 300. The attachment point is shown without the connector 224 in FIG. 5. Notably, in the depicted embodiment, the attachment point 300 is a cuboidal component that includes an open-top cavity 302. The cavity 302 extends between a front wall 306 and a back wall 308 and is sized to receive the actuatable engagement member 225 while the engagement member 225 is actuated (e.g., by squeezing actuator 226 against arm 220). That is, when the connector 224 is actuated, the flange 227 can be placed flush against the front wall 306 of the attachment point 300 and the engagement member 225 can extend into cavity 302 without contacting (and frictionally engaging) the front wall 306. Consequently, the connector 224 can move vertically with respect to the attachment point 300 when the actuator 226 is actuated. Then, upon release of the actuator 226, the engagement member 225 may move back towards the flange 227 so that the flange 224 and engagement member 225 clamp the connector 224 to the front wall 306 of the attachment point 300.

Alternatively, in some embodiments, the engagement member 225 may be biased outwards (away from the distal end 223 of arm 220) and may move closer to flange 227 when the actuator 226 is actuated. That is, actuating actuator 226 may cause engagement member 225 to retract, at least slightly, towards flange 227, and allow the engagement member 225 to move out of contact with the back wall 308 of the attachment point 300. In these embodiments, upon release of the actuator 226, the engagement member 225 extends outwards, into engagement with back wall 308. The portion of the back wall 308 facing the cavity 302 includes receptacles 304 that allow the engagement member 225 to extend outwards. The receptacles 304 are sized to mate with the engagement member 225 and, thus, when the engagement member 225 is aligned with one of the receptacles 304 and the actuator 226 is released, the connector 224 will be securely coupled to the attachment point 300.

In FIG. 5, the attachment point 300 is movably coupled to a column 120 of a welding tractor's support structure. More specifically, the attachment point 300 includes a flange 310 that rides within a vertical slit 121 included in a wall of column 120. This allows the attachment point 300 to move vertically with respect to the column 120 so that the position of the arm 220 (and, thus, the position of the welding head 200) can be adjusted accordingly. The attachment point 300 may be releasably secured in a particular vertical position in any desirable manner (e.g., via detent stops, a mechanical pin, etc.). Alternatively, in other embodiments, the attachment point 300 may be attached to the support structure of an automated welding system in any manner.

Moreover, in other embodiments, any desirable connection may secure the arm 220 (and, thus, the welding head 200) to a support structure for an automated welding system (e.g., a tractor, column and boom assembly, robot, etc.). However, notably, with the connector 224 and attachment point 300 illustrated in FIGS. 4 and 5, the connection is tool-less. That is, the connector 224 and attachment point 300 illustrated in FIGS. 4 and 5 form a mechanical connection (e.g., a snap-fit connection) that secures the welding head 200 to a support structure for an automated welding system without the use of a tool. Electrical or gas connections between the welding head 200 and other components of the automated welding system (e.g., the controller and power source) can be disconnected and connected independently of this mechanical connection and need not be handled concurrently with the mechanical connection. Many other automated solutions provide electrical connections within a mechanical connection between a welding head and a support structure. Here, any electrical or gas connections are provided via leads 160 that are independent of the mechanical connection between the welding head 200 and the support structure.

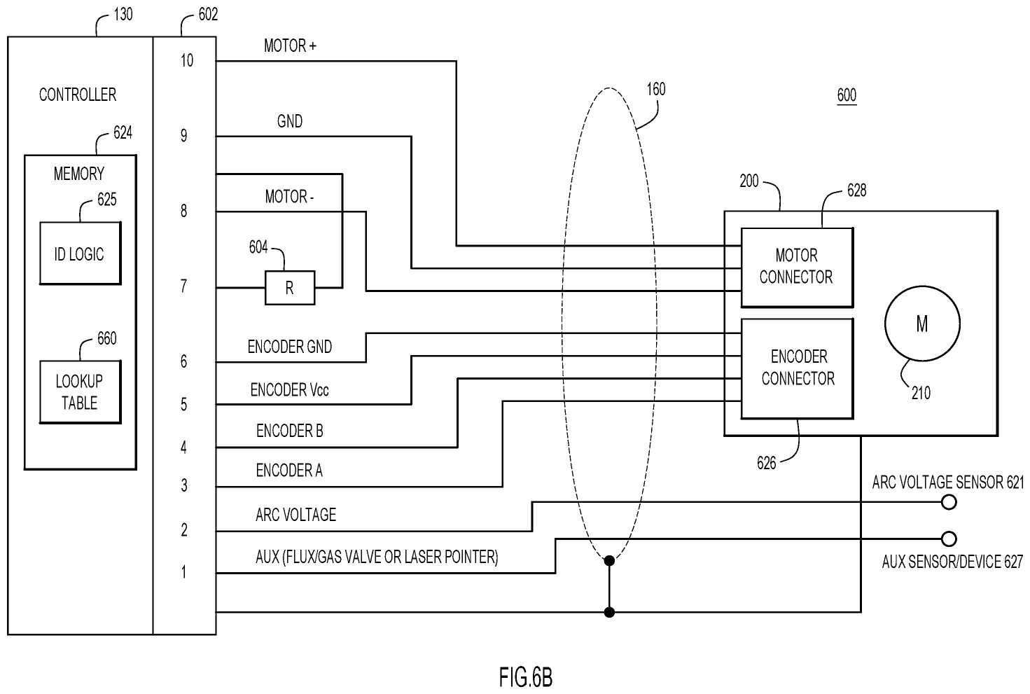

Now turning to FIGS. 6A and 6B, these Figures illustrate two example embodiments of the wiring connection between a welding head and a controller which, as mentioned, is independent of the mechanical connection between the welding head and the support structure. In these embodiments, each interchangeable welding head that is suitable for the automated welding system presented herein includes wiring harness/cabling 160 (depicted as leads 160 in FIG. 1) with an 10-pin connector 602 with one pin (pin 7) including an identifying resistor 604, which will have a unique resistive value corresponding to the purpose of the welding head, as is discussed in further detail below in connection with FIGS. 7 and 8. However, as mentioned, these Figures illustrate only example embodiments and, in other embodiments, the resistor 604 need not be included in the wiring harness/cabling 160 and, instead, can be included in/on a welding head itself. As a more specific example, in FIG. 6A, the resistor 604 may be built into the filter board of a printed circuit board (PCB) 622 included in the gouging head.

Moreover, in some embodiments, the interchangeable welding heads and/or their wiring harness/cabling might include any type of electrical identifier instead of a resistor. For example, any type of circuitry that can create a different electrical unique identifier can be used, including a capacitor, inductor, filter, etc. Still further, an interchangeable welding head (or its wiring harness/cabling) might include memory that stores its identity (e.g., a one wire memory). If a memory is used as the identifier, the memory might also store information such as the type of consumables that are suitable for the head, and service information (like contact tip data).

Regardless of the type of electrical identifier included in the interchangeable welding heads, the circuitry may differ, at least slightly, from head to head. For example, the circuitry 600 shown in FIG. 6A depicts a wiring harness 160 for a gouging head. In this wiring harness 160, pin 1 connects the controller 130 to an arc voltage sensor 621 included at the gouging head and pin 2 connects the controller 130 to an air pressure sensor 623 included at the gouging head. Pins 3 and 4 are connected to an encoder included in the controller 130 (and, thus, are labeled as Encoder A and Encoder B), pin 5 is the voltage common collector for the encoder, and pin 6 is the ground pin for the encoder. Meanwhile, pin 7 includes the identifying resistor 604, pin 8 and 10 provide negative and positive terminals for motor power (e.g., motor 210) and pin 9 provides grounding. The encoder connections (e.g., pins 3-6) allow an encoder in the controller 130 to monitor wire feed speed while the motor connections (e.g., pins 8-10) allow the controller 130 to control the motor speed (and, thus, wire feed speed) based on feedback from the encoder.

By comparison, the circuitry 650 depicted in FIG. 6B depicts a wiring harness suitable for a SAW or GMAW head that is largely the same as the circuitry 600 depicted in FIG. 6A and, thus, any description of like components included in FIGS. 6A and 6B is to be understood to apply to the components of both FIGS. 6A and 6B. However, in circuitry 650 the resistor 604 is now in a closed loop with pin 7 (the grounding pin), pin 1 connects the controller 130 to an auxiliary sensor or device 627 included at the gouging head, such as a flux valve, a shielding gas valve, or a laser pointer, and the encoder connections (e.g., pins 3-6) and the motor connections (e.g., pins 8-10) connect the controller 130 to a encoder connection 626 and motor connection 628, respectively, included in the SAW/GMAW welding head 200. Notably, The filter board 622 is placed on the gouging head shown in FIG. 6A because the motor 210 for this head is smaller and needs a cleaner supply to run smooth as compared to the GMAW/SAW head shown in FIG. 6B.

Still referring to FIGS. 6A and 6B, but now with reference to FIG. 7 as well, the controller 130 can include memory 624. The memory 624 may store identifying logic 625 (ID logic 625) and may also store or have access to a lookup table 660. The identifying logic 625 allows the controller 130 to identify an interchangeable welding head 200 that is electrically connected to the controller 130 and allows the controller 130 to adjust welding parameters and/or welding components accordingly.

Now turning to FIG. 7 for a description of a method 660 for identifying a welding head and automatically configuring a welding system for the welding head. For clarity, the operations depicted in FIG. 7 are described as being performed by a controller (e.g., controller 130); however, this is not intended to be limiting and, in other embodiments, these operations may performed, executed, or caused to execute by any entity.

Initially, at 662, the controller identifies a welding head that is mechanically and electrically coupled to the automatic welding system in which the controller is included. In at least some embodiments, identifying a welding head includes, at 664, detecting a new head has been attached to the automatic welding system. In some embodiments, a sensor may be included on the support structure of the automatic welding system (e.g., a sensor may be included in attachment point 300) and the controller 130 may detect a new welding head based on feedback that the sensor is sensing a mechanical connection. In other embodiments, the controller 130 may detect a new welding head when the wiring in a wiring harness intended to connect the controller 130 to a welding head forms a closed circuit and/or at startup of the controller 130. Regardless, once a new welding head is detected at 664, the controller determines a resistance value for an identifying resistor included in the new welding head at 666. At 668, the controller utilizes the resistance value to determine an identity of the new welding head. For example, the controller may query a lookup table with the resistance value to determine the identity of the new welding head at 668.

Turning briefly to FIG. 8, this Figure depicts an example lookup table 690. In this table, unique resistor values are correlated with different types of welding heads. For example, a resistance of 100 ohms corresponds to a SAW welding head, a resistance of 220 ohms corresponds to high speed twin SAW, a resistance of 680 ohms corresponds to GMAW welding, and a resistance of 2200 ohms corresponds to gouging. Additionally, in the depicted lookup table 690, the resistive value 8200 ohms corresponds to manual configuration that is not associated with specific welding parameters, 0 ohms and infinity ohms correspond to faults for short and open circuits, respectively, and various additional resistance values are reserved so that additional welding heads can be added to the lookup table 690. However, in other embodiments, any desirable values may correspond to any desirable heads. Moreover, in at least some embodiments, an open circuit can also be used to trigger a manual setting menu so that a welding head without a resistor can then be used with the system.

Now turning back to FIG. 7, but with continued reference to FIG. 8, once the controller identifies a welding head, the controller may determine, at 670, various configuration parameters based on the identity. Then, at 672, the controller 130 may set or present the configuration parameters. In at least some embodiments, the configuration parameters are included in the lookup table, as is shown in FIG. 8. For example, if the welding head is identified as a SAW head (based on an identifying resistor with a resistance of 100 ohms), the controller may set the motor speed to 38 rotations per minute (rpm), set the motor gearing to 49:1, set the feed roll to 49 mm, and set the encoder to pulse at 28 pulses per rotation based on information included in lookup table 690. In addition or as an alternative to the settings shown in the lookup table 690, the controller 130 may activate or deactivate certain components of the automated system. For example, if the welding head is identified as a SAW head, the controller may activate a flux subsystem (e.g., by sending instructions to the welding head to open a flux nozzle), but if the welding head is a GMAW head, the controller may deactivate the flux subsystem and activate a gas subsystem to provide shielding.

Still further, based on the identity of the welding head, the controller may update or control menus presented to an end user. For example, if the welding head is identified as a GMAW head, the controller may present menu options on a graphical user interface (GUI) that ask the end user to identify the consumable as aluminum or mild steel wire and to confirm that only a single wire is being used for the welding operations. Additionally, the controller may present menu options on the GUI that allow the end user to input settings for pre- and post-welding gas flow, as well as parameters for direct current (DC) power. By comparison, if the welding head is identified as a SAW head, the controller may present menu options on the GUI that ask the end user to identify the consumable as stainless steel, mild steel, or cored wire. Additionally, the controller may present menu options for flux post flow, scratch or direct start, etc., and/or alternating current (AC) power. As still another example, if the welding head(s) are identified as twin SAW heads(s), the controller may present menu options that require the user to indicate whether the wires twin wires are 2×1.6 mm mild or stainless, 2×2.4 mm mild or stainless, etc., and/or options that allow the user to set parameters for alternating current (AC) power. As one final example, if the welding head is identified as a gouging head, the controller would request that the user inputs a gouging rod selection. In at least some embodiments, the menu options or ranges of menu options may also depend on the apparatus (e.g., the specific tractor) hosting an identified welding head, as well as the subsystems mounted thereon (e.g., gas and/or flux subsystems).

Based on the identification of a welding head and/or selections input by a user, the controller can adjust various welding parameters. Welding parameters include welding equipment parameters that have a direct influence on the welding process, such as welding current, welding speed (i.e., the speed of movement in the welding direction WD), consumable feed speed, feed speed of a leading consumable, and feed speed of a trailing consumable. Additionally or alternatively, the welding parameters may include or be characteristics of the welding, such as the stick out of the weld, penetration of the weld, length of an arc, etc. Any welding parameter may be measured based on any data or feedback provided to or gathered by the controller (i.e., provided to the controller by sensors). For example, the motor speed of a welding head may be measured to determine the feed speed of a consumable.

Moreover, in some embodiments, the resistors or other such electrical identifiers might be included in other components other than a welding head, such as a flux subsystem, gas subsystem, motorized base, etc., and the controller may be able to identify these components in the same manner used to identify a welding head discussed herein (e.g., by determining a resistance and utilizing a lookup table to identify the component based on the resistance). Then parameters of these components can be adjusted in a similar to the manner discussed above for welding heads in connection with FIG. 7 (however, these components can also be controlled based on the identity of the welding head even when these components are not specifically identified). For example, the speed of a motorized base may be adjusted based on the identity of a base and/or the identity of a welding head installed on the base. Additionally or alternatively, a range of base speeds may be displayed at the controller based on the identities of the base and the welding head.

Still referring generally to FIG. 7, in some embodiments, the controller may identify two heads at step 662, for example, if the automated system is being setup for tandem welding. In such a scenario, the controller (which may comprise a single controller with two processors, a single controller with a single processor, or two or more sub-controllers (e.g., two controllers that are synchronized and collectively referred to as a controller)) may determine settings that are suitable for both heads or determine settings on a per-head basis (i.e., determine separate settings for the two heads).

Put more generally, when one or more welding heads are installed onto the automated welding system presented herein, the automated welding system will simplify setup for the user. The system will setup a motor controller to control consumable feeding, setup the power source to provide power within parameters that are suitable for identified welding head(s), and/or activate welding features that are required for the identified welding head(s). In some embodiments, the system may also select the appropriate consumable for the identified welding head(s). Alternatively, the system will create menus that are specific to the identified welding head(s) so that a user can select only settings suitable for the identified welding head(s). The system could also provide an indication of consumables that are suitable for the identified welding head(s). Still further, in some embodiments, the system may also show the user the settings that were last utilized for the identified welding head(s). Consequently, a user can quickly and easily repurpose automated welding equipment for different types of welding without having to perform rigorous checks and reconfigurations and without significantly disassembling the equipment.

Now referring to FIG. 9 for a description of a computer system 701 upon which the techniques presented herein may be implemented. The computer system 701 may be representative of the controller 130 illustrated throughout the figures.

The computer system 701 includes a bus 702 or other communication mechanism for communicating information, and a processor 703 coupled with the bus 702 for processing the information. While the figure shows a single block 703 for a processor, it should be understood that the processors 703 represent a plurality of processing cores, each of which can perform separate processing. The computer system 701 also includes a main memory 704, such as a random access memory (RAM) or other dynamic storage device (e.g., dynamic RAM (DRAM), static RAM (SRAM), and synchronous DRAM (SD RAM)), coupled to the bus 702 for storing information and instructions to be executed by processor 703. In addition, the main memory 704 may be used for storing identification logic 625 (see FIGS. 6A and 6B), or at least a portion thereof, temporary variables or other intermediate information, such as lookup table 660, during the execution of instructions by the processor 703.

The computer system 701 further includes a read only memory (ROM) 705 or other static storage device (e.g., programmable ROM (PROM), erasable PROM (EPROM), and electrically erasable PROM (EEPROM)) coupled to the bus 702 for storing static information and instructions for the processor 703. For example, ROM 705 may be used for storing identification logic 625 (see FIGS. 6A and 6B), or at least a portion thereof, and/or lookup table 660. That is, memory 704 and/or ROM 705 may be representative of memory 624 from FIGS. 6A and 6B.

The computer system 701 also includes a disk controller 706 coupled to the bus 702 to control one or more storage devices for storing information and instructions, such as a magnetic hard disk 707, and a removable media drive 708 (e.g., floppy disk drive, read-only compact disc drive, read/write compact disc drive, tape drive, and removable magneto-optical drive, optical drive). The storage devices may be added to the computer system 701 using an appropriate device interface (e.g., small computer system interface (SCSI), integrated device electronics (IDE), enhanced-IDE (E-IDE), direct memory access (DMA), or ultra-DMA).

The computer system 701 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)), that, in addition to microprocessors and digital signal processors may individually, or collectively, are types of processing circuitry. The processing circuitry may be located in one device or distributed across multiple devices.

The computer system 701 may also include a display controller 709 coupled to the bus 702 to control a display 710, such as liquid crystal display (LCD), or a light emitting diode (LED) display, for displaying information to a computer user. The computer system 701 includes input devices, such as a keyboard 711 and a pointing device 712, for interacting with a computer user and providing information to the processor 703. The pointing device 712, for example, may be a mouse, a trackball, or a pointing stick for communicating direction information and command selections to the processor 703 and for controlling cursor movement on the display 710. The pointing device 712 may also be incorporated into the display device as, for example, a capacitive touchscreen and/or a resistive touchscreen.

The computer system 701 performs a portion or all of the processing steps of the invention in response to the processor 703 executing one or more sequences of one or more instructions contained in a memory, such as the main memory 704. Such instructions may be read into the main memory 704 from another computer readable medium, such as a hard disk 707 or a removable media drive 708. One or more processors in a multi-processing arrangement may also be employed to execute the sequences of instructions contained in main memory 704. In alternative embodiments, hard-wired circuitry may be used in place of or in combination with software instructions. Thus, embodiments are not limited to any specific combination of hardware circuitry and software.

As stated above, the computer system 701 includes at least one computer readable medium or memory for holding instructions programmed according to the embodiments presented, for containing data structures, tables, records, or other data described herein. Examples of computer readable media are compact discs, hard disks, floppy disks, Universal Serial Bus (USB), magneto-optical disks, PROMs (EPROM, EEPROM, flash EPROM), DRAM, SRAM, SD RAM, or any other magnetic medium, compact discs (e.g., CD-ROM), or any other optical medium, punch cards, paper tape, or other physical medium with patterns of holes, or any other medium from which a computer can read.

Stored on any one or on a combination of non-transitory computer readable storage media, embodiments presented herein include software for controlling the computer system 701, for driving a device or devices for implementing the invention, and for enabling the computer system 701 to interact with a human user (e.g., a network engineer). Such software may include, but is not limited to, device drivers, operating systems, development tools, and applications software. Such computer readable storage media further includes a computer program product for performing all or a portion (if processing is distributed) of the processing presented herein.

The computer code devices may be any interpretable or executable code mechanism, including but not limited to scripts, interpretable programs, dynamic link libraries (DLLs), Java classes, and complete executable programs. Moreover, parts of the processing may be distributed for better performance, reliability, and/or cost.

The computer system 701 also includes a communication interface 713 coupled to the bus 702. The communication interface 713 provides a two-way data communication coupling to a network link 714 that is connected to, for example, a local area network (LAN) 715, or to another communications network 716 such as the Internet. For example, the communication interface 713 may be a wired or wireless network interface card to attach to any packet switched (wired or wireless) LAN. As another example, the communication interface 713 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 713 sends and receives electrical, electromagnetic or optical signals that carry digital data streams representing various types of information.

The network link 714 typically provides data communication through one or more networks to other data devices. For example, the network link 714 may provide a connection to another computer through a local area network 715 (e.g., a LAN) or through equipment operated by a service provider, which provides communication services through a communications network 716. The local network 714 and the communications network 716 use, for example, electrical, electromagnetic, or optical signals that carry digital data streams, and the associated physical layer (e.g., CAT 5 cable, coaxial cable, optical fiber, etc.). The signals through the various networks and the signals on the network link 714 and through the communication interface 713, which carry the digital data to and from the computer system 701 maybe implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 701 can transmit and receive data, including program code, through the network(s) 715 and 716, the network link 714 and the communication interface 713. Moreover, the network link 714 may provide a connection through a LAN 715 to a mobile device 717 such as a personal digital assistant (PDA) laptop computer, or cellular telephone.

To summarize, in one form, a method is provided comprising: identifying a welding head that is mechanically and electrically coupled to the automatic welding system; determining one or more welding components and one or more parameters associated with the welding head; and initiating welding with the welding head with the one or more welding components and the one or more parameters determined to be associated with the welding head.

In another form, an apparatus is provided comprising: a support structure; a plurality of welding heads that are each removably, mechanically coupleable to the support structure; a controller that is configured to control welding operations of the automated welding system based on an identity of a particular welding head of the plurality of welding heads that is mechanically coupled to the support structure and operably coupled to the controller.

In yet another form, one or more non-transitory computer-readable storage media is provided encoded with software comprising computer executable instructions and when the software is executed operable to: determine one or more ranges of allowable values for each of the one or more parameters; display menu options that are within the one or more ranges; and receive user selections of the menu options and set the parameters in accordance with the user selections.

Although the techniques are illustrated and described herein as embodied in one or more specific examples, the specific details of the examples are not intended to limit the scope of the techniques presented herein, since various modifications and structural changes may be made within the scope and range of the invention. For example, as mentioned, the interchangeable welding heads presented herein may be installable on a column and boom (e.g., the column and boom may include attachment point 300) or any other welding support system, such as robots, gantries, etc., and a controller associated with this support system may perform the techniques described herein that are largely described in connection with a tractor. That is, the automated welding system presented herein may be embodied as a column and boom welding system, a robotic welding system, or any other type of welding system utilized for automated welding.

Additionally, various features from one of the examples discussed herein may be incorporated into any other examples. For example, the techniques associated with identifying the welding head described in connection with the tractor 100 shown in FIG. 1 may also be implemented by controllers included on other tractors (e.g., the tractors shown in FIGS. 2A and 2B), as well as other systems (e.g., column and boom type systems). Accordingly, the appended claims should be construed broadly and in a manner consistent with the scope of the disclosure.

We claim:

1. A method for configuring an automatic welding system, comprising:
identifying a welding head that is mechanically and electrically coupled to the automatic welding system;
determining one or more welding components and one or more parameters associated with the welding head; and
initiating welding with the welding head with the one or more welding components and the one or more parameters determined to be associated with the welding head.

2. The method of claim 1, wherein the identifying further comprises:
identifying the welding head based on a resistance value of an identifying resistor included in the welding head or cabling for the welding head.

3. The method of claim 2, wherein the determining further comprises:
querying a lookup table with the resistance value.

4. The method of claim 1, wherein the welding head is an interchangeable welding head that is coupled to a support structure of the automatic welding system via a releasable mechanical coupling.

5. The method of claim 4, wherein the releasable mechanical coupling is a tool-less coupling.

6. The method of claim 1, wherein the welding head is an interchangeable welding head that is coupled to a controller of the automatic welding system and a power source of the automatic welding system via releasable electrical couplings.

7. The method of claim 1, wherein the one or more parameters are selected from a group including: wire feeder gear ratios, wire feed speed, encoder pulse setting, gas flow rates; welding voltage, welding current, flux flow, and travel speed.

8. The method of claim 1, wherein the one or more welding components include a flux subsystem and/or a gas subsystem.

9. An automated welding system comprising:
a support structure;
a plurality of welding heads that are each removably, mechanically coupleable to the support structure; and
a controller that is configured to control welding operations of the automated welding system based on an identity of a particular welding head of the plurality of welding heads that is mechanically coupled to the support structure and operably coupled to the controller.

10. The automated welding system of claim 9, wherein each of the plurality of welding heads includes an identifying resistor with a unique resistive value and the controller identifies the particular welding head based on its unique resistive value.

11. The automated welding system of claim 9, wherein the support structure comprises a base and a column of a welding tractor.

12. The automated welding system of claim 9, wherein the support structure comprises a column and boom.

13. The automated welding system of claim 9, further comprising:
a flux subsystem that can be selectively activated to provide flux for the welding operations of specific welding heads of the welding heads.

14. The automated welding system of claim 9, further comprising:
a gas subsystem that can be selectively activated to provide shield gas for the welding operations of specific welding heads of the welding heads.

15. The automated welding system of claim 9, wherein the controller controls the welding operations by limiting a range of one or more parameters, including voltage, travel speed, current, and wire feed speed.

16. The automated welding system of claim 9, wherein each of the plurality of welding heads is removably, mechanically coupleable to the support structure via a tool-less coupling.

17. The automated welding system of claim 9, wherein the support structure is configured to support two or more welding heads of the plurality of welding heads at once and the controller controls the welding operations based on identities of each of the two or more welding heads.

18. One or more non-transitory computer readable storage media encoded with software comprising computer executable instructions and when the software is executed operable to:
identify a welding head that is mechanically and electrically coupled to an automatic welding system;
determine one or more welding components and one or more parameters associated with the welding head; and
initiate welding with the welding head with the one or more welding components and the one or more parameters determined to be associated with the welding head.

19. The one or more non-transitory computer readable storage media of claim 18, wherein to determine the one or more parameters associated with the welding head, the software is operable to:
determine one or more ranges of allowable values for each of the one or more parameters;
display menu options that are within the one or more ranges; and
receive user selections of the menu options and set the parameters in accordance with the user selections.

20. The one or more non-transitory computer readable storage media of claim 18, wherein to identify a welding head that is mechanically and electrically coupled to an automatic welding system, the software is operable to:
identify the welding head based on a resistance value of an identifying resistor included in the welding head.
